(19) United States
(12) Patent Application Publication
(10) Pub. No.: US 2007/0175308 A1
(43) Pub. Date: Aug. 2, 2007

(54) Cutter apparatus

(76) Inventor: Mumtaz Shah, Manchester (GB)

Correspondence Address: WILLIAM COLLARD;COLLARD & ROE, P.C., 1077 NORTHERN BOULEVARD, ROSLYN, NY, 11576, US

(21) Appl. No.: 10/593,860

(22) PCT Filed: Mar. 22, 2005
(86) PCT No.: PCT/GB05/01065

§ 371 Date: Nov. 28, 2006

(30) Foreign Application Priority Data
Mar. 22, 2004 (GB) 0406313.7

(51) Int. Cl. B26D 5/08

(52) U.S. Cl. 83/588; 83/627; 83/467.1

(57) ABSTRACT

Cutter apparatus comprises a maneuverable body having an upper part (10) adapted for control and a lower part (11) in the form of a horse shoe shaped slider. The parts are connected by a ploughshare shaped blade holder (13) which is attached to the lower part (11) and extends into the upper part to present a cutting edge (15) towards the direction of motion of the body. Protrusions (17, 18) are provided on a lower face of the upper part (10) to guide paper between the parts and present and tension the paper to the cutting edge (15). Notches (19, 20) in the lower part (11) enable the body to follow a straight edge or template.

This invention relates to a cutter apparatus for use in cutting sheet material such as paper, cloth or plastics such as PVC etc.

In WO 98/48981 I have disclosed apparatus for cutting sheet material which comprises a hand-manoeuvrable body comprising separate superimposed upper and lower parts with a gap between wherein sheet material can be received. The parts are physically connected only by a blade, or combination of blade and blade holder, and a pressure means in the form of a freely rotatable wheel is provided to tension the sheet in front of the blade. The gap may be sinusoidal, by forming the facing surfaces of the upper and lower parts with suitable contours for support and tensioning of the sheet, and a window or other viewing means is provided for viewing the sheet in front of the blade.

It has been found that the capabilities of this early model of blade and/or sheet cutting apparatus are limited in some respects. Whilst cuts can be made to follow curved lines and in particular, it has been found that the radius of curvature attainable and the minimum width of cut of material is limited and a minimum radius of curvature for clean, snag-free cutting by the blade is imposed. It is also found that, as in most such devices, a sharp edge is left to the paper or other sheet material which can cause finger cuts.

It is an object of the invention to provide a cutter apparatus for use in cutting sheet material such as paper cloth or plastics which has improved flexibility in use, for example attaining shorter radius curvature of clean snag-free cutting, and improved capabilities in other respects such as accuracy of tracking and/or measuring, and preferably avoidance of finger cuts.

According to the invention, cutter apparatus comprises, an upper part and a lower part, a cutting means extending between the parts and forming the sole connection between the parts and provided with a cutting means, the upper part comprising a body adapted for manual manipulation, and the lower part providing opposed surfaces, a lower gliding surface and an upper sheet guide surface for guiding the sheet between the parts and presenting the sheet to the cutting means for cutting.

The cutting means is preferably a blade with a leading cutting edge, but other means may be used, such as a pair of bearings or steel or plastic rollers which create a cut.

The apparatus preferably provides tensioning means in a zone around the blade, at least in front of and preferably to each side and extending behind the blade, in the form of protrusions on either the upper or lower parts of the apparatus. The protrusions are preferably provided one to each side of the blade and may be contoured to guide the paper by means of a curved lead-in surface. The pressure acting on the tensioning means may vary in response to changes in pressure exerted by a user on the upper part of the apparatus.

The cutting means may include a ploughshare or wedge or otherwise shaped part, which guides and/or forces the cut edges of the sheet apart to create a snag-free cut, and acts to soften the cut edge of the paper or other sheet, to avoid skin cuts.

The lower part of the apparatus may be provided with notches or channels for cooperating with a rule or straight edge or other e.g. curved template to guide the cutter apparatus for example for edge trimming.

A preferred embodiment of cutter apparatus according to the invention will now be described with reference to the accompanying drawings, wherein:

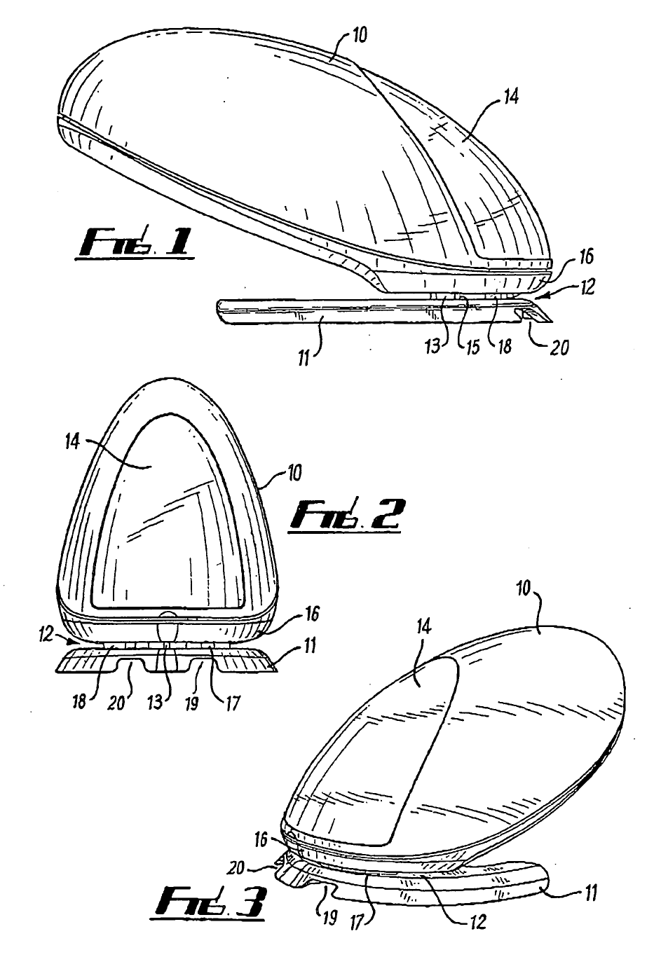

FIG. 1 is a side elevation view of cutter apparatus according to the invention;

FIG. 2 is a front elevation of the apparatus shown in FIG. 1;

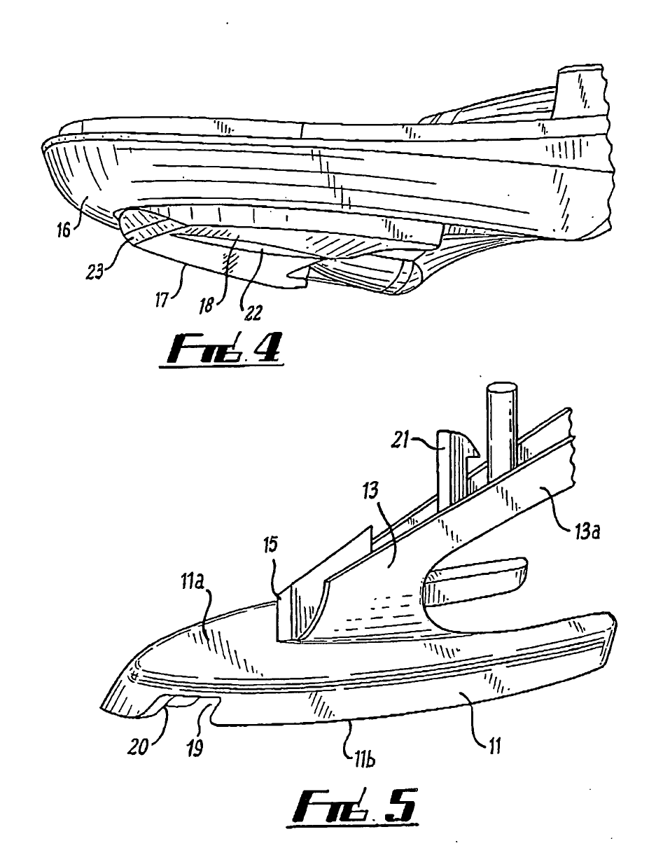

FIG. 3 is a perspective view of the cutter apparatus of FIGS. 1 and 2.

FIG. 4 is a perspective view of first dismounted part of the cutter; and

FIG. 5 is a perspective view of a second dismounted part of the cutter.

The cutter apparatus according to the invention shown in the drawings comprises an upper body 10, and a horse-shoe shaped lower shoe 11 which are separated by a gap 12, and connected by a blade and holder combination 13 which as shown in FIG. 5 is mounted on the shoe 11, and extends into the upper body 10. The upper body 10 comprises a plastics or the like shell which is hollow but can be filled or partially filled, having a transparent window 14 or other viewing means in the front thereof, and the shell is shaped in a manner similar to an egg to be comfortably placed under the palm of a user's hand. It can if required be of any other suitable shape.

The blade/holder combination 13 features a fixed or replaceable blade with a cutting edge 15 at the leading edge of the blade. The holder 13 is configured as a wedge or ploughshare with wings 13a diverging upwardly into the upper body 10. A hook or clip 21 is provided to latch the shoe 11 into the upper body, in a releasable or a permanent connection.

The upper body 10 has a base part 16 which is shown obliquely from below in FIG. 4, which provides an upper guide surface bounding the gap 12, whilst the upper face of the shoe 11 provides a lower guide surface 11a bounding the gap 12. The upper body may comprise a separately moulded cover part which is joined to the base part 16 to form the body 10.

The upper guide surface in the gap 12, formed on the base part 16 is formed with tensioning means which takes the form of a protrusion 17, 18 providing an extended flat surface to either side of and in front of a slot 22 for the blade/holder combination 13, and with a curved leading face 23 so that paper presented to the gap 12 to pass between the body 10 and shoe 11 is tensioned in the zone immediately in front of the cutting edge 15 as the cutter is pushed by hand to the right in FIG. 1, thereby bringing the paper under tension to the edge 15 and thus ensuring a clean cut. The protrusion can also be a part or more than one part placed around the blade, in front thereof and to each side and extending behind the latter.

The shoe 11 is formed with downwardly open notches 19, 20 to the front, one to each side of the centre line (or blade locus) of the cutter, which enable a rule or other straight edge or a curved template for cutting curves, or circles or to a prepared design to be inserted below the shoe 11, to guide the cutter as it is moved forward in a straight or other required cut, for example in edge-trimming sheets, or other more varied work. The cutter or blade may be interchangeable for different uses.

The cutter can also be used freehand for making freehand cuts, for example for use in cutting out to a pattern following pre-drawn lines in zig-zags, patterns or other shapes. The window 14 helps with this as the precise alignment of the cutting edge can be followed visually so that the path of the cutter can be manually adjusted by the user to follow a pre-drawn line.

The shoe 11 provides an under surface 11b, either as a continuous under surface (save for the notches 19, 20) or as the lower edges of a peripheral skirt and is of general horse-shoe shape (best indicated in FIG. 5), although it can be of a semi-elliptical or oval shape or any other shape, which under surface provides a low resistance so that the shoe can be conveniently slid on a drawing board, desk or table surface below the paper, to move the cutter in response to control movements of the user manipulating cutter.

The pressure exerted by the user or otherwise may act if required to vary the tension exerted by the protrusions 17, 18 and the latter present a curved leading edge 23 (see FIG. 4) for guiding the paper into the gap 12 towards the cutting blade edge 15 without snagging of the paper or other sheet material. Alternatively, the paper may be tensioned by means of other means such as wheels, rollers, spheres, or other configurations of protrusion or bearing surface, and maybe located in front of the blade or alongside the blade, or behind.

As the blade edge 15 is within the cutter with only a narrow gap between the parts 10, 11 and thus not accessible to fingers, the cutter is safe to use even for children or people with disabilities. The body 10-maybe of any suitable shaped desired for functional or aesthetic reasons.

The improved cutting capabilities are obtained by holding the paper flat between the protrusion 17 and upper surface 11a of the shoe, in a zone leading to the blade edge 15. Further, from the cut, the edges of the paper are drawn up and parted by riding up the sides of the ploughshare or wedge or other shaped blade holder part 13, and the cut edges are abraded and slightly turned over by contact with part 13 so the edges of the cut do not present a sharp edge which might cause injury such as paper cuts.

Variations may be made to the cutter device within the scope of the invention. For example, the lead in surface 23 of the tensioning means can be a surface of any shape which is suitable to guide and tension the paper to provide a clean cut. The protrusion may be of any shape or form, and may not be part of either the base 26 nor the shoe 11, but be a separate part designed to tension or hold the sheet material. The window 14 may be, or be replaced by any effective viewing means which could if required include a magnifying device or lens arrangement.

Whilst described for usual use on a support surface such as a desk, the cutter device may be used free of support as pressure may not always be required. Use without pressure may be more effective with some sheet material than others.

It is of course to be understood that the invention is not intended to be restricted to the details of the above embodiments which are described by way of example only.

1. Cutter apparatus for use in cutting sheet material; comprising an upper part (10) and a lower part (11); a blade and holder means (13) extending between the parts and forming the sole connection between parts and provided with a cutting means (15), the upper part (10) comprising a body adapted for manual manipulation, wherein the lower part (11) and upper part (10) provide surfaces on opposed faces thereof, a gliding surface on the underside the lower part (11) and a sheet guide surface (11a) on the upper side thereof for guiding the sheet between the parts (10 and 11) and for presenting the sheet to the cutting means (13) for cutting.

2. Cutter apparatus according to claim 1, wherein the cutting means comprises a blade with a leading cutting edge (15).

3. Cutter apparatus according to claim 1, wherein further tensioning means is provided in a zone around the blade means (13), at least in front of the blade means (13) in the form of protrusions (17, 18) on either the upper (10) or lower (11) parts of the apparatus.

4. Cutter apparatus according to claim 1, wherein the cutting means (13) includes a ploughshare or wedge or other shaped part, which guides the cut edges of the sheet to part and rise and acts to soften the cut edges of the sheet to avoid skin cuts.

5. Cutter apparatus according to claim 3, wherein said tensioning means are further provided to each side of and extending behind the blade means (13).

6. Cutter apparatus according to claim 3, wherein the protrusions (17, 18) are provided one to each side of the blade means (13), and are contoured to guide the paper by means of a curved lead-in surface 23.

7. Cutter apparatus according to claim 3, wherein the protrusions (17, 18) are formed as ridges of rounded profile.

8. Cutter apparatus according to claim 1, wherein the lower part (11) of the apparatus is provided with notches or channels (19, 20) for cooperating with a rule or straight edge or other template to guide the cutter.

9. Cutter apparatus according to claim 1, wherein the upper part (10) of the apparatus comprises a plastics shell in the form of an eccentric flattened ovoid.

10. Cutter apparatus according to claim 9, wherein the upper part (10) has a transparent window (15) in the front thereof.

11. Cutter apparatus according to claim 1, wherein the lower part (11) is in the form of a generally horse-shoe shaped shoe.

12. Cutter apparatus according to claim 1, wherein the blade means (13) comprises a blade and holder combination which presents the cutting edge (15) towards the direction from which paper is presented thereto.

13. Cutter apparatus for use in cutting sheet material substantially as hereinbefore described, with reference to and as illustrated in the accompanying drawings.
